(19) United States
(12) Patent Application Publication
(10) Pub. No.: US 2008/0300780 A1
(43) Pub. Date: Dec. 4, 2008

(54) METHOD FOR AUTOMATING TASK WITH PORTABLE DEVICE

(76) Inventor: Dmitry Domnin, Olathe, KS (US)

Correspondence Address: MARK BROWN, 4700 BELLEVIEW SUITE 210, KANSAS CITY, MO, 64112, US

(21) Appl. No.: 12/111,067

(22) Filed: Apr. 28, 2008

Related U.S. Application Data
(63) Continuation-in-part of application No. 11/147,077, filed on Jun. 7, 2005, now abandoned.
(60) Provisional application No. 60/650,496, filed on Feb. 7, 2005.

(51) Int. Cl. G01C 21/00

(52) U.S. Cl. 701/202; 701/213

(57) ABSTRACT

A system and method are provided for automating procedures, such as navigation, using a portable device with a camera and adapted for receiving input. As configured, the automated procedures are associated with various input signals, such as locations, orientations and destinations in connection with navigational procedures. The output can include directions and menu choices for various destinations. Upon receipt of an input signal, the portable device processes the input and initiates the automated procedure associated with the input signal. The portable device can also communicate with a communications provider or a service provider for transmitting information related to the automated procedure to be preformed.

### CROSS-REFERENCE TO RELATED APPLICATIONS

This application is a continuation-in-part of Ser. No. 11/147,077 filed Jun. 7, 2005, now abandoned, which claims the benefit of U.S. provisional application Ser. No. ______ filed Jun. 8, 2004, and U.S. provisional application No. 60/650,496 filed Feb. 7, 2005.

### BACKGROUND OF THE INVENTION

1. Field of the Invention

The present invention relates generally to automated procedures, such as locating positions and performing navigational procedures using static objects for determining positions and orientations, for example, where Global Navigation Satellite System (GNSS) signals are either not available or are inadequate for a desired precision.

2. Description of the Related Art

It is not uncommon for routine tasks to be repeated on a periodic basis. Some routine tasks involve receiving and transmitting various items of information before and during the performance of the task. Because of the time involved in performing repetitive tasks, it would be beneficial to have a method of automatically performing tasks.

Procedures to be automated change as the needs of the individual change. For example, while a person with children may have a need to pay monthly childcare bills, a person without any children may not have the same financial commitments. Therefore, it would be beneficial to have a method for automating different tasks which can be configured or adapted to be used for different automated procedures depending on the user's automation needs.

In addition, although some current automation systems allow for user input, these systems may utilize larger or stationary electronic devices which are not easily transported. These larger devices also may not be designed for being used while transported for use. It would therefore be beneficial to have a method for automating tasks which uses a compact portable device which is easily transported allowing the user to automate different tasks throughout the day.

Many navigational systems use GNSS (e.g., Global Positioning System (GPS)) RF signals to determine locations. However, with a single-antenna GNSS device orientation cannot be determined until the device begins to move, in which case the direction of travel can be determined. GNSS devices are also somewhat limited by their requirement of unrestricted line-of-site (LOS) views of the satellites in the particular GNSS constellation utilized by the device in order to receive adequate satellite signals for computing position fixes.

### SUMMARY OF THE INVENTION

In the practice of an aspect of the present invention, a method is provided for automating procedures using a portable device. The method includes associating the automated procedure with at least one input signal, inputting the input signal into the portable device and initiating the associated automated procedure in response to the input signal. In the practice of another aspect of the present invention, a precise navigation system and method and are provided and involve a portable device with a camera for optically scanning an indicia located on a static surface. A user's position coordinates and orientation can be obtained from a single scan without using a GNSS device.

### BRIEF DESCRIPTION OF THE DRAWINGS

FIG. 1 is a block diagram of a system adapted for using the method of the present invention.

FIG. 2 is an environmental diagram of the present invention

FIG. 3 is a flow diagram of a method of the present invention.

FIG. 4 is another flow diagram of the present invention.

FIG. 5 is a flow diagram of another method of the present invention.

FIG. 6 is a now diagram of another method of the present invention.

FIG. 7 is a flow diagram of another method of the present invention utilizing two input signals.

FIG. 8 is an environmental diagram of a navigational application comprising another method of the present invention.

FIGS. 8a-8h show various navigational situations in which the present invention is utilized for position and orientation.

FIG. 9 is a flow diagram of the present invention utilizing two input signals.

FIG. 10 is an illustration of a merchant payment application of the present invention.

FIG. 11 is an illustration of a bill payment application of the present invention.

FIG. 12 is an illustration of an application of the present invention.

FIGS. 13a, 13b are diagrams of indicia configurations.

FIGS. 14a, 14b are flow charts showing options for obtaining current location position fixes.

FIG. 15 is a flow chart for another method of determining a current location using non-unique indicia for mapping and navigation.

FIG. 16a is a diagram of a combination map and directory display for a facility.

FIG. 16b is an enlarged plan comprising a portion of the display shown in FIG. 16a and shows a shopping mall.

### DETAILED DESCRIPTION OF THE PREFERRED EMBODIMENTS

### I. Introduction and Environment

As required, detailed embodiments of the present invention are disclosed herein: however, it is to be understood that the disclosed embodiments are merely exemplary of the invention, which may be embodied in various forms. Therefore, specific structural and functional details disclosed herein are not to be interpreted as limiting. but merely as a basis for the claims and as a representative basis for teaching one skilled in the art to variously employ the present invention in virtually any appropriately detailed system or method.

Referring to the drawings in more detail, the reference numeral 20 generally designates a method for automating a task with a portable device (APD) embodying the present invention. Without limitation on the generality of useful applications of the present invention, the disclosed embodiments comprise a method for automating at least one task in connection with a portable device 22. Other types of applications involving automating procedures for use with a portable device based on the same could utilize the method 20 of the present invention. For example, the method 20 of the present invention can be utilized in connection with business processes, domestic tasks, educational activities and recreational activities. The method 20 includes the portable device 22, which can be in communication with different devices for performing or initiating different aspects of the method 20.

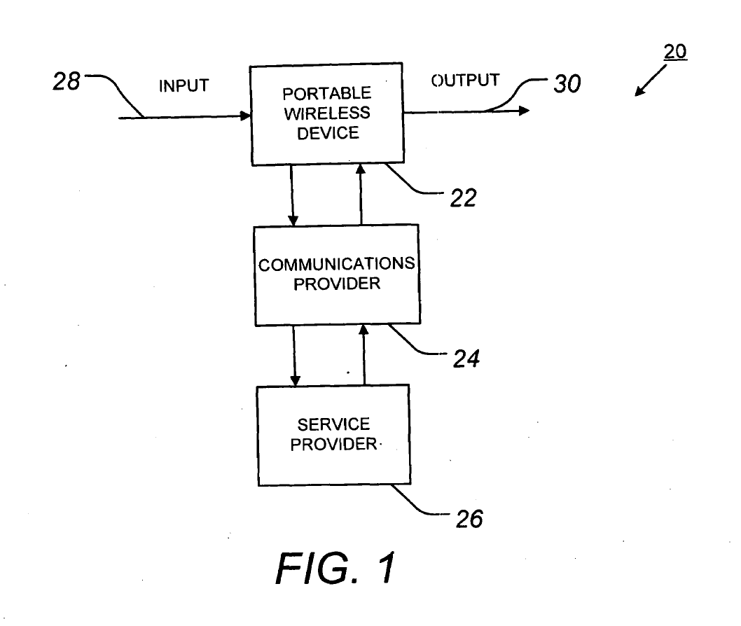

The portable device 22 is illustrated in FIG. 1 having an input 28. the portable device 22 initiating a procedure in response to the input 28 as an output 30. The input 28 can be a number of different input types. such as but not limited to a digital input signal, an analog input signal, an optical input signal an auditory input signal and a radio frequency input signal. The output 30 being varied may include, but is not limited to, initiating a procedure for modifying a schedule or contact information, a merchant transaction procedure, initiating a phone call, initiating a navigational request, displaying a navigational instruction, initiating a payment procedure, initiating a look-up or reference request procedure, a data entry procedure, data transfer procedure, data generation transaction, a communication request, or initiating a response to a communication request or other automated procedures which utilize at least one input to the portable device 22. In FIG. 1 the automated procedure initiated by the portable device 22 generates the output 30.

Alternatively, the portable device 22 may be configured to communicate with others such as a communications provider 24 or a service provider 26. The portable device 22 may transmit to and receive information from the communications provider 24 and optionally the service provider 26 if they are in communication with one another. An example of the communications provider 24 may be a telecommunications provider while an example of the service provider 26 may be a retailer or an c-commerce merchant. The automated procedure may be initiated at the portable device, the communications provider or the service provider depending on the configuration of the specific application of the present invention.

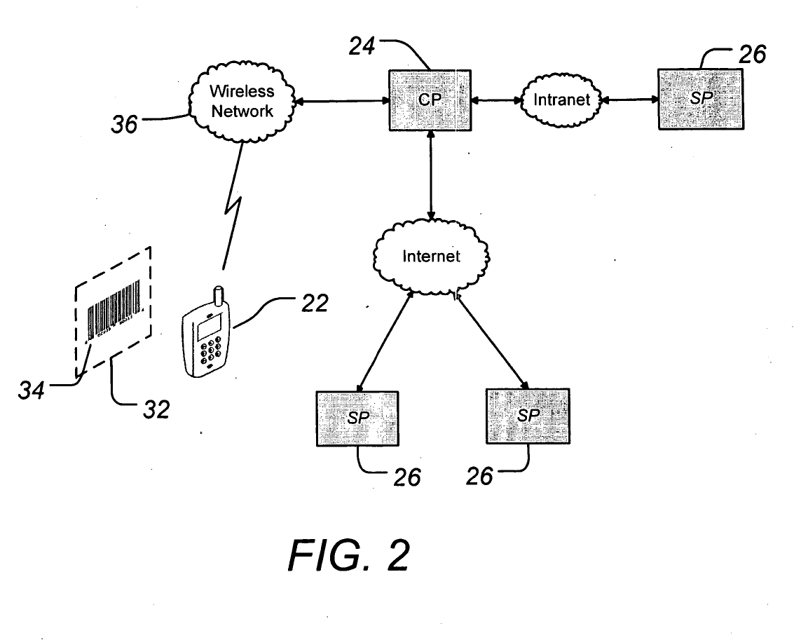

As an illustration of the method 20 embodied in the present invention, FIG. 2 depicts a scanning application with the portable device 22 being a wireless camera phone directed towards a product 32 having a product code 34 being located within the operational proximity of the portable device 22. Plural automated procedures are associated with plural input signals such that when the portable device 22 receives the input signal 28, the associated automated procedure 30 is initiated. Associated automated procedures include the initiation of data transmission, the initiation of a phone call, the display of a geographic proximity such as a map, the initiation of a payment transaction to a merchant and the translation of a document or image. In addition, plural wireless devices can be configured for use with the present invention, each wireless device having a unique identifier identifying the wireless device by the telecommunications provider.

The portable device 22 in the application depicted in FIG. 2 is placed in operational proximity with the communication provider (CP) 24 through a wireless network 36. When the portable device 22 optically records the product information or code 32, the recording may be converted to the specific product 32 by using bar code or optical character recognition technologies or other comparative algorithms. This automated recognition procedure may be initiated by the portable device 22. Alternatively, the portable device 22 can initiate an automated transmission procedure for transmitting the recorded information to the communications provider 24 for translation. Once the product code 34 has been determined, another automated procedure can be initiated such as, but not limited to an automated purchase procedure for purchasing the product 32 which corresponds to the product code 34. Alternatively, the communications provider 24 may identify the product 32 and based on the associated automatic procedure, initiate additional procedures like initiating a price look-up procedure transmitting the automated procedure output to any configured service providers to provide pricing and product information for the product 32 for determining who has the lowest priced product 32. The gathered information may be transmitted to the communications provider 24, or the portable device 22, for initiation of a product purchase procedure where the lowest priced in-stock product 32 is purchased. In addition, upon initiation of the product purchase procedure, additional information may be provided including shipping address and payment information such as a credit card or bank account information for completing the product purchase procedure.

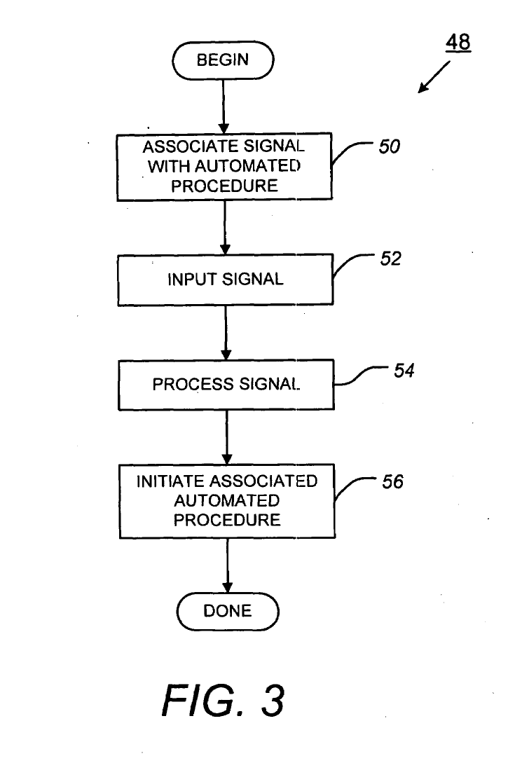

As illustrated in FIG. 3, a method 48 of practicing the invention generally includes the steps of associating the input signal with the automated procedure at 50, receiving the input signal at 52 by the portable device and then processing the signal at 54 and finally initiating the associated automated procedure 56 in response to the input signal. The initiation may be as simple as forwarding the signal to another user or as complex as providing a navigational map indicating direction of travel. In each of these applications, the input step 52 is used to initiate the application at step 56.

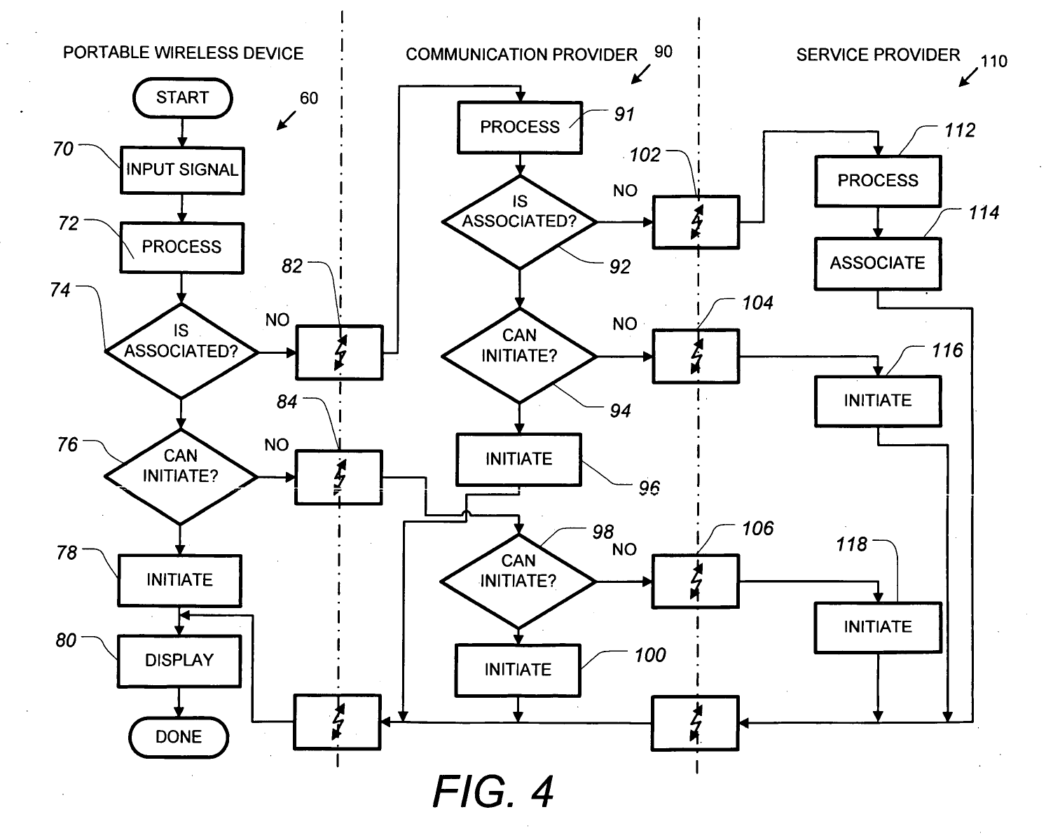

An illustration of a method 60 utilizing the present invention is shown in FIG. 4, with the input signal received at 70 and processed at 72 by the portable device. Based upon the determination of whether the signal is associated with any particular automated procedure at 74 the automated procedure is initiated at 78 and the results are optionally displayed on the portable device at 80. In this illustration, the method 60 utilizes the portable device as a stand alone device, receiving the input signal at 70, processing it at 72 and initiating the automated procedure at 78 within the same device. Alternatively, a method illustrated at 90 may be utilized for communicatively connecting the portable device with the communications provider, permitting either the associating decisional step 74, the initiating decisional step 76 or both 74, 76 to be preformed by the communications provider method 90. In such a configuration, the input signal is still received at 70 and processed by the portable device at 92; however, if the communications provider is configured to associate the signal with the automated procedure at 74, the processed input signal is transmitted at a communication interconnection 82 from the portable device to the communications provider for processing the signal at 91 and initiating the automated procedure at 96. The method 90 may be desired, for example, when configuring a large number of portable devices in a similar manner or when the associating step 92 involves a relatively large amount of data.

Alternatively, the method 90 may include configuring the portable device to associate the automated procedure at 74 with the input signal, while the communications provider may be configured to perform the initiate decisional step at 98. In this scenario, the portable device transmits the associated automated procedure to the communications provider at communications interconnection 84 for initiating the automated procedure at step 100. This method 90 may be desired when the automated procedure requires bandwidth either in terms of volume, duration or both to perform the automated procedure. An example of such a request may be when the automated procedure initiates a low price search related to a specific product code input signal in which a large volume of data may be necessarily reviewed to provide the lowest price to the user. Without transmitting the automated procedure to the communications provider, the portable device may be unavailable to perform other tasks for some time.

In addition to the method 90 providing communication between the portable device and the communications provider, FIG. 4 illustrates another method 110 utilizing the present invention which combines the earlier methods 60, 90 for communicating between the service provider and the portable device. In the method 110, the communications provider transmits the processed input sign 91 via the communications interconnection 102 for processing the input signal at step 112 and associating the input signal at 114. Alternatively, the portable device may transmit the processed input signal at step 72 via the communications interconnection 84 through the communications provider of method 90, through the communications interconnection 106, initiating the associated automated procedure at step 118 as determined by the portable device in method 60 at step 74. In this manner, the flexibility and scalability of various methods for use with the current invention may be adapted for a variety of different automated procedure applications.

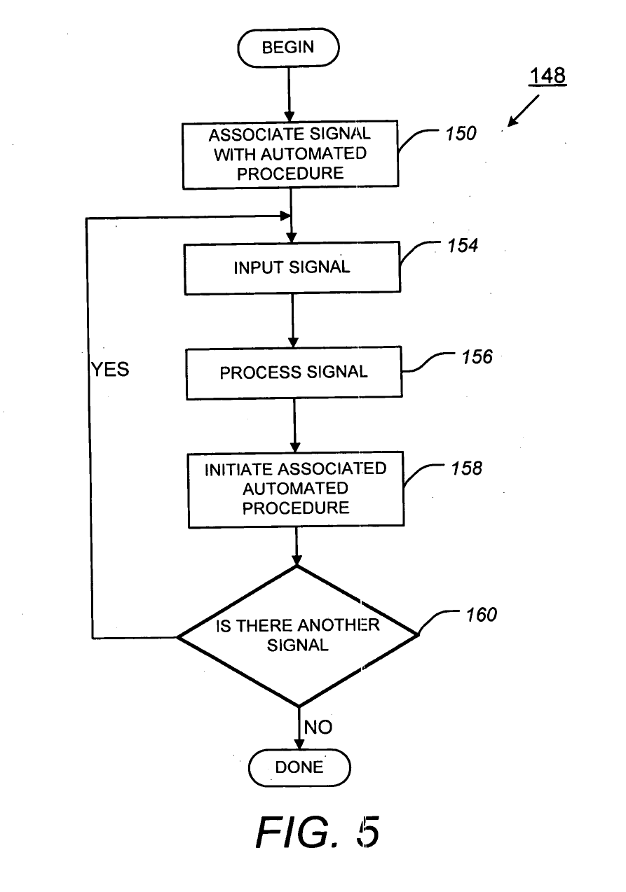

In general, as shown in FIG. 1 the input signal 28 is received by the portable device 22 for processing and initiating the automated procedure 30. Optionally, as illustrated in FIG. 5, a method 148 for practicing the current invention may include additional input signals received by the portable device. After the input signal is associated with an automated procedure at step 150 and after the input signal is received at step 154, the input signal is processed at step 156 and the associated automated procedure is initiated at step 158. In addition, further input signals as determined at step 160, are received at step 154. In this way, additional automated procedures may be initiated at step 158 based upon the receipt of additional input signals at step 160.

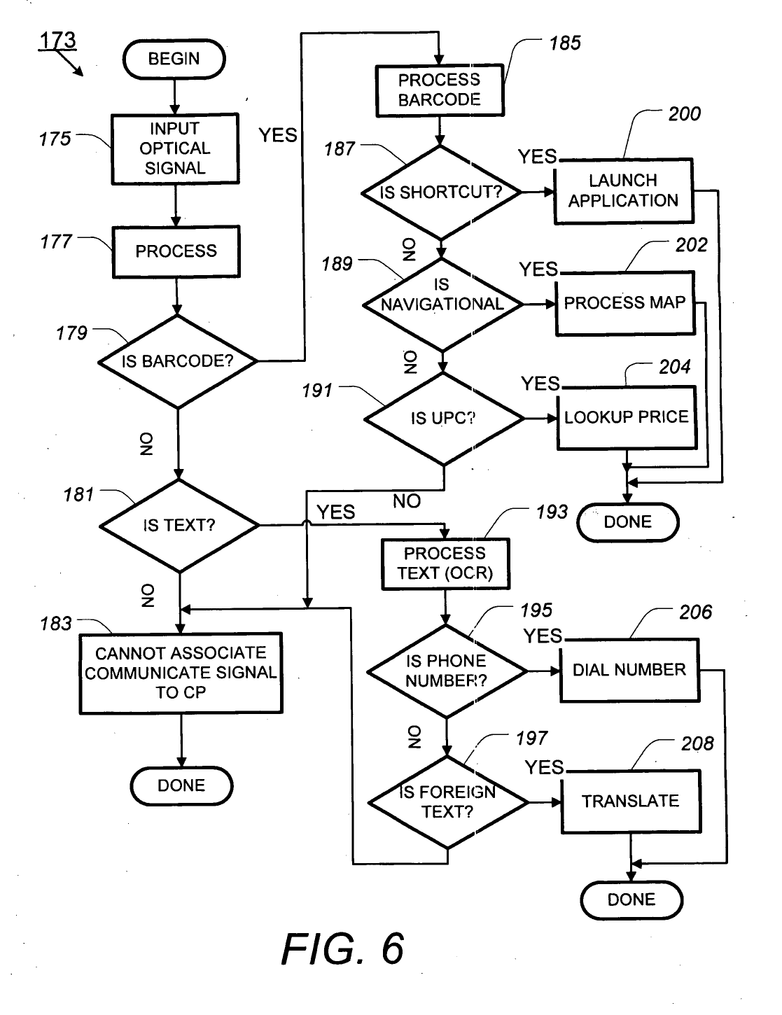

A method 173 of practicing the invention is illustrated in FIG. 6 with multiple automated procedures associated with different input signals. After receipt of an optical input signal at step 175 the signal is processed at step 177 using the portable device which can communicate using standard telecommunication and internet protocols. After determining whether the input signal represents a barcode at step 179, using for example optical recognition techniques, the bar code is processed at step 185 to determine if the barcode represents a shortcut to an executable application at step 187. a navigational instruction at step 189 or a product code such as the UPC code at step 191. If the determination is that the input signal is not a barcode at step 179. the signal may be evaluated to determine if it represents text at step 181. If the input signal represents text as determined at step 181, the signal is processed using for example optical character recognition techniques at step 193. If it is decided that the input signal does not represent either a barcode or text the current method 173 may decide that the input signal cannot be processed at step 183 and the method 173 will end.

As a barcode, the optical signal may include information related to an executable application as determined at step 187 which may be initiated at step 200. the barcode may include navigational information as determined at step 189 in which case a navigational procedure may be initiated at step 202 or the barcode may include product information as determined at step 191 in which case a price look-up procedure may be initiated at step 204. If it is determined that the optical signal is text at step 181, the text is processed at step 193 and further evaluated to determine if it represents a phone number at step 195 and in need of initiating a phone call at step 206 or if the text represents foreign text as determined at step 197, initiating a translation procedure at step 208.

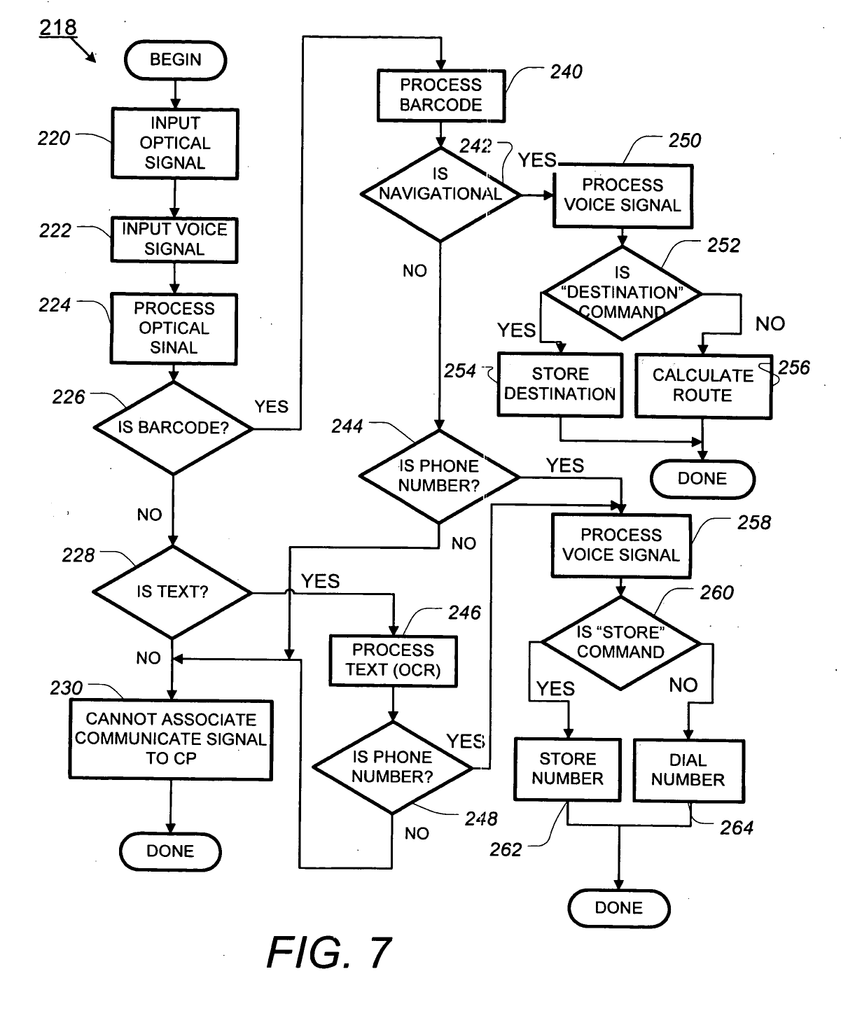

Another illustration of a method 218 of practicing the current invention is depicted in FIG. 7 in which multiple inputs are received at steps 220 and 222, a first input being an optical input signal as illustrated at step 220 and a second input being illustrated as an audio signal at step 222. Upon receipt of the input signals at steps 220 and 222, the first input is processed at step 224 and a determination is made at step 226 about whether the first input is a barcode, if so the barcode is processed at step 240. If the first signal is not a barcode, a determination is made at step 228 about whether the first input signal represents text. If the input signal represents text, it is processed at step 246 using standard comparative technologies, such as but not limited to current optical character recognition technologies.

Upon determining that the first input is a barcode in step 240, the input is further evaluated and a determination is made at step 242 whether the input is navigational or whether the input is a phone number at step 244. If the input is navigational, the second input is processed at step 250 and a determination is made whether the audio input signal is a destination command at step 252. If the audio input signal represents a destination command, the processed barcode at step 240 is stored as a destination in step 254. Otherwise, the optical input signal is considered a navigational map input and a route is calculated at step 256.

If the barcode is determined at step 244 to represent a phone number, the audio input signal is processed at step 258 and evaluated for a store command at step 260. If the audio input signal represents a store command, the processed barcode is stored as a phone number in step 262. Otherwise, the processed audio input is considered a dial command and the phone number is dialed at step 264.

Upon determining that the first input is text in step 228, and processing the text at step 246, the text is evaluated to determine if it is a phone number at step 248 and if so, the audio input signal is evaluated at step 258 as previously described. However, as illustrated in the method 218, if the processed optical input signal at step 246 is not a phone number according to step 248, then the method 218 is unable to associate the input signal and the input signal is transmitted at step 230 to the communications provider, if any, for processing. Method 218 is an illustration utilizing two input signals and is provided for assisting one skilled in the art to understand how to practice the invention. Alternatively, additional input signals and additional automated procedures may be utilized for practicing the current invention.

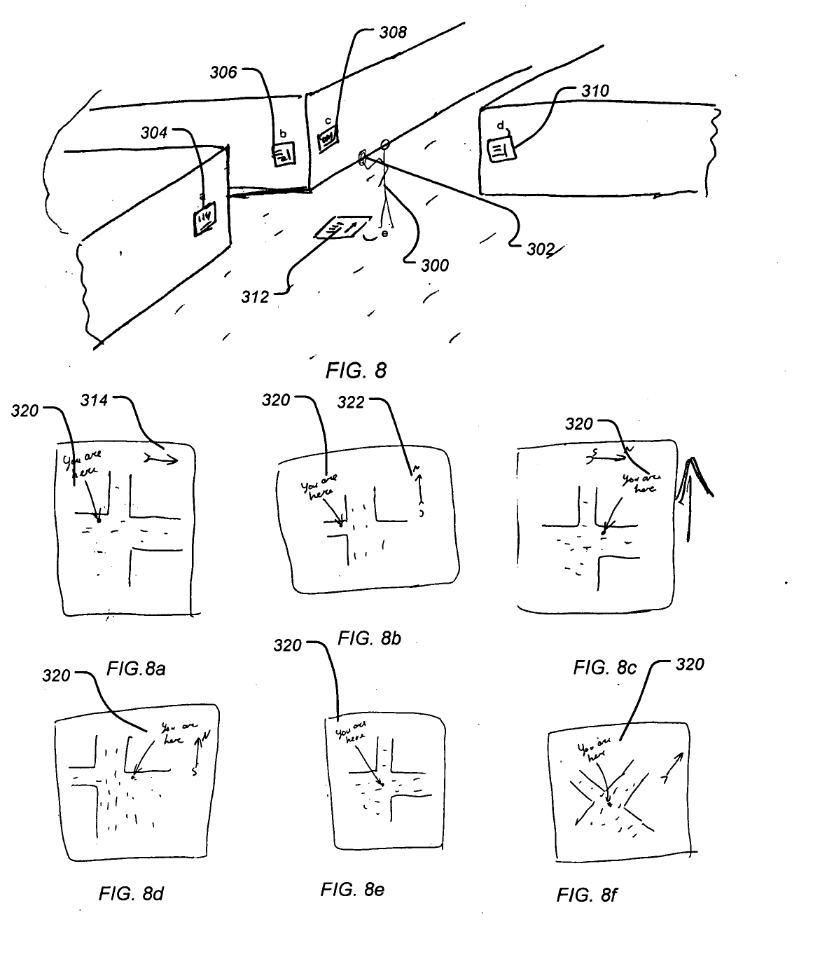

Another illustration of an application of the present invention is the navigational automated procedure illustrated in FIG. 8 where a user 300 having a portable device 302 enters a facility with wall-mounted indicia 304, 306, 308, 310 and floor-mounted indicia 312 in sight. The user can direct the portable device 302 to the floor indicia 312 to read his or her current location. The portable device scans the optical indicia, extracts the data and needed to identify the indicia and associates the indicia with the location. The navigational (mapping) function displays a map 320 centered on the current position as shown in FIGS. 8e, 8f. The angle of rotation of the map on the device screen depends on the orientation of the user 300 with respect to the indicia 312, e.g., the direction from which the user 300 approached the indicia 312. If the user 300 approaches one of the four wall-mounted indicia 304, 306, 308, 310, the map resulting from reading such indicia will be as shown in FIGS. 8a, 8b, 8c or 8d respectively.

In general, when the portable device 302 is pointed at optical indicia 304, 306, 308, 310 or 312 a mapping automated procedure is initiated and the portable device displays a navigational map in accordance with corresponding indicia orientation. Specifically, when the portable device 302 is pointed at the optical indicia 304 located on a substrate positioned on a wall the portable device 302 records the optical indicia 304 and the recording is input into the portable device 302 as an optical input signal. The optical input signal representing the optical indicia 304 may be optionally displayed on the portable device 302 allowing the user 300 to confirm the input. Once the portable device 302 has received the optical input signal, the device 302 may initiate the navigational automated procedure associated with the input signal, for example but not limited to a mapping request, the result may be displayed on the display screen associated with the portable device as indicated in FIGS. 8a-8h. In addition, if the optical indicia 304 includes information related to the current position of the portable device 302, such as GPS coordinates or another method of representing the current location. as illustrated in FIGS. 8a-8f, the portable device's 302 current location 320 may be displayed on the associated display screen along with the navigation results.

FIG. 8a is an illustration of a graphical display resulting from the automated navigation procedure associated with the optical input signal recorded from the optical indicia 304 located on the wall. An arrow 314 showing direction to geographical North is optional and is shown to indicate map orientation. Optical indicia 304 may include destination information, which allows the user 300 to navigate to the specified destination using the device display as shown in FIG. 8a. Subsequent markings may be provided to assist the user 300 when changing directions. Alternatively, the portable device 302 may include a GPS antenna and receiver to provide current location information for use by the portable device 302 in calculating travel direction and destination direction. FIG. 8b is an illustration of a graphical display resulting from the automated navigational procedure associated with the optical input signal recorded from the optical indicia 306 located on a nearby wall. The graphical display shown in FIG. 8b also provides a relative direction indication 322 of the relative direction of the user with reference to magnetic north indicated by an arrow pointing north. FIG. 8c is an illustration of the graphical display resulting from the automated navigational procedure associated with the optical indicia 308 located on the adjacent wall and FIG. 8d illustrates the graphical display resulting from the automated navigational procedure associated with the optical indicia 310 located on an opposite wall.

In addition to vertical surfaces, in the navigation application the system can receive optical input signals representing optical indicia located on horizontal surfaces such as floors, tables or ceilings as indicated in FIGS. 8e-8h. FIG. 8e represents the resulting screen if the user approaches the indicia 312 from the direction N (340). FIG. 8f represents an approach from the direction S (346) and FIGS. 8g and 8h represent approaches from directions E (342) and SE (344) respectively. The arrows shown on each drawing are optional and are shown to indicate what the user would see if pointing in the same direction as the optional arrow 311 on indicia 312. The graphical display of the navigational automated procedure initiated upon receipt of a representation of the optical indicia 312 located on the floor is illustrated in FIG. 8e. FIG. 8f illustrates the graphical display of the automated navigational procedure upon receipt of the optical input signal representing the optical indicia 312 after rotating the portable device 302 in a generally 45 degree angle clockwise in reference to the indicia 312. Optical indicia 312 is placed on the substrate orientated towards a specific direction, such as magnetic north, allowing the portable device to compare the received optical signal with the referenced optical signal to determine the signal rotation. When rotation is detected, the portable device may calculate the deviation and display the deviation on the graphical screen through a comparative algorithm.

Alternatively, the substrate can include a radio frequency identification (RF1D) tag and the portable device can include a radio frequency identification reader for reading the RFID tag within the substrate. Upon interrogation of the RFID tag by the reader, the RFID tag provides information related to a current location and a destination. Upon receipt of the RFID input signal, the portable device can initiate the automated navigation procedure associated with the RFID input to direct the portable device to the specified destination displaying the results graphically on the portable device's 302 display screen.

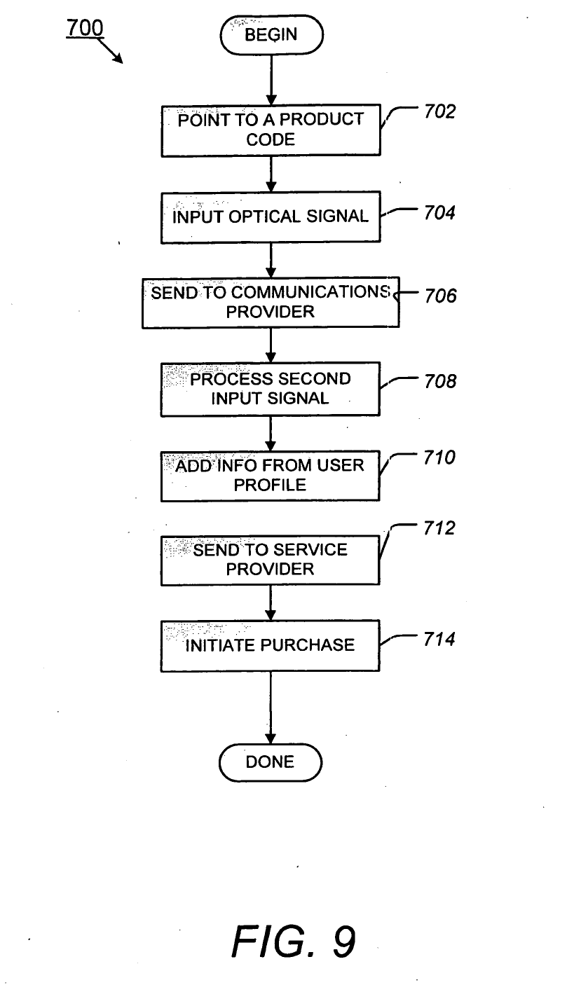

The present invention includes applying the method of the invention to a merchant and consumer transaction in which the portable device receives an optical input signal and in response initiates an automated purchase procedure where information about a product and the user of the portable device are provided to automate the transaction. For instance, the method 700 shown in FIG. 9 may be used when a consumer having a portable phone with a camera enters a merchant's place of business, the consumer directing the portable device to a product on the shelf, optically recording the barcode as indicate at step 702, inputting the recorded barcode at step 704 into the portable device as an optical input signal. The optical input signal may be decoded by the portable device, or transmitted to the communications provider via a telecommunications network as indicated at step 706 for processing the optical input signal. After processing the barcode, the automated procedure may include purchasing a product corresponding to the barcode processed from the optical input signal. This automated procedure may be performed by the portable device, any connected communications provider or connected service providers who receive the product request. Alternatively, the associated automated procedure may be a product look-up procedure to search for a product and its related price, transmitting the results to the portable device. Upon receipt of the product information, the portable device may display the results on the associated display screen allowing the user to compare the various prices for the product. In this way, the method of the present invention allows the user of the portable device to make a more informed transaction decision.

Optionally, the product may be purchased from any associated service provider using a second input signal. When purchasing the product from the service provider, an audio input signal or other input signal may be provided which is processed at step 708 for initiating the associated automated purchase procedure. In addition, additional information may be provided from a user profile at step 710 including a payment method or any shipment information, the information and purchase request being transmitted to the service provider at step 712 for initiating the purchase at step 714.

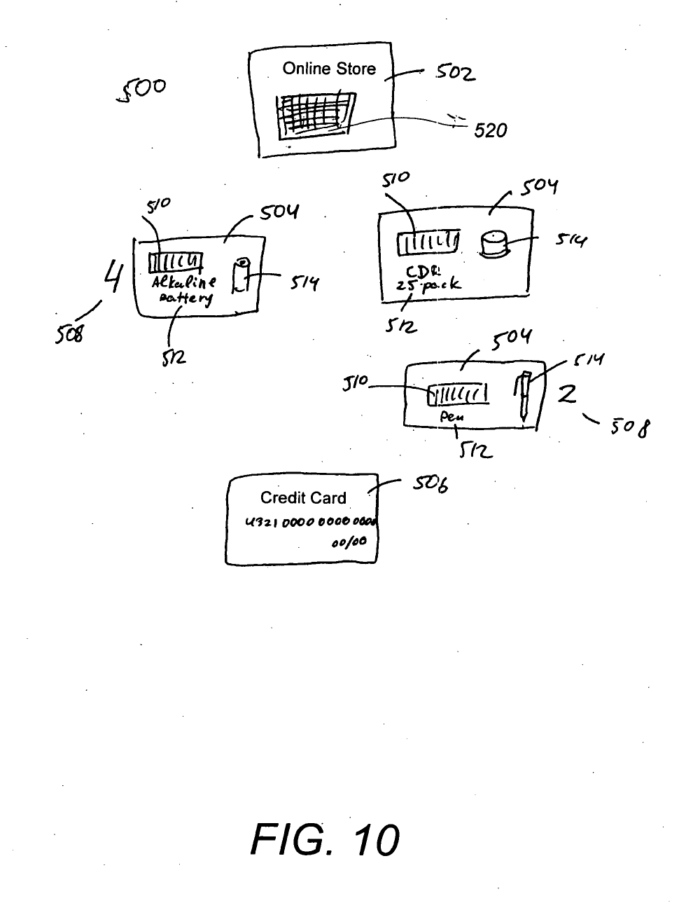

Another merchant to consumer transaction automated procedure application is depicted in FIG. 10 in which the portable device is used in conjunction with multiple optical indicia 514 located on a substrate 504 to initiate the automated purchase procedure. Product identifiers such as product name 512, barcode 510 or a product icon 514 representing the different products are arranged on substrate 504 for recording by the portable device. In addition, quantity identifiers 508 may be provided to indicate that a number of the identified products are to be purchased. Alternatively, the recorded barcodes or text can be retrievably stored by the portable device or some other storage device. Upon receipt of a recorded product identifier the portable device may process the optical image, converting the image to an optical input signal. In addition to product information, the portable device may receive payment information 506 from a recorded image, the image being converted and input to the portable device. Once the product and payment 506 information are received by the portable device, the automated purchase procedure associated with the input signal may be initiated to purchase the products 504 associated with the product identifiers 510, 514. Additional information may be stored and transmitted by the portable device, the communications server, the service provider or any combination thereof. Optionally, if the user desires to specify the service provider 502 to receive the automated procedure, a service provider identifier 520 may be input to the portable device for processing by the portable device or communications provider allowing the automated procedure to be initiated by the specified service provider 502.

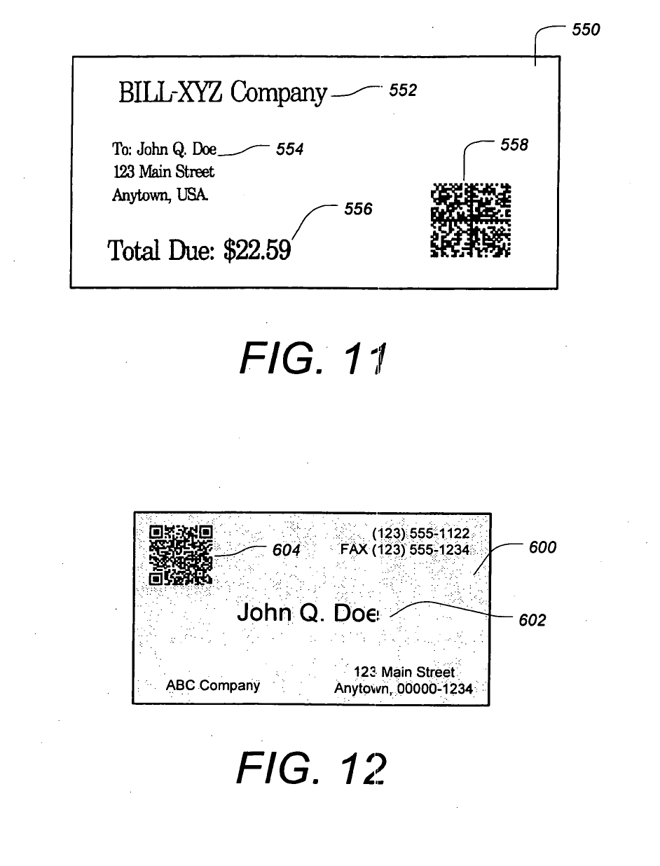

An application of the present invention including an automated payment procedure is illustrated in FIG. 11. Specifically, a billing statement 550 is provided, including a company name 552, debtor's name 554 and address along with amount due 556 which is optically recorded by the portable device. Alternatively, a billing statement may include a machine readable optical indicia 558 like a bar code which contains company name, user name and address along with amount due. Once the various indicia are optically recorded and received by the portable device as an optical input signal, they are then processed using character or barcode recognition technology. Once processed, the portable device may initiate a payment procedure where the bill statement is paid by a payment account configured by the portable device user.

Alternatively, the billing statement 550 may be presented to a customer at a time of purchase. The customer using their portable device may initiate payment of the statement using a dynamically generated display by the point of sale device which is recorded and converted by the portable device to an optical input signal. The dynamically generated display contains a machine readable code for facilitating the purchase transaction including the merchant's bank account information which is forwarded to the portable device user's payment provider to coordinate payment of the point of sale billing statement.

Another application of the present invention is illustrated in FIG. 12 with a business card 600 including company information as text 602 or as a machine readable code 604. Upon receipt by the portable device of an optical input signal corresponding to the optical indicia 602, 604 located on the card 600, the portable device may initiate a contact update with the contact information located on the card 600 or the portable device may initiate a payment transfer to the contact identified on the card 600 based upon the receipt of a second audio input signal associated with one of the automated procedures.

FIGS. 13a and 13b show samples of indicia encapsulating origin and destination information. For example, in FIG. 13a the upper half 52 represents origin coordinates and the lower half 54 represents destination coordinates. Indicia 56 in FIG. 13b comprise data representing a binary code, which can be used to query a database to get a record associated with the indicia 56. A record may represent a set of geographical coordinates corresponding to a single location, a pair of origin and destination coordinates sets, or other information. Moreover, the record is not limited to static data but may have a procedure or an algorithm associated with it, which association may be changed with time. For example, a current promotion or advertisement related to a particular business at a designated location may be included in the destination information indicia and may be updated as appropriate.

FIGS. 14a and 14b are flowcharts showing procedures using unique indicia for getting current locations. In FIG. 14a, the indicia are shown with binary data containing current geographical coordinates so that the navigational software can access such coordinates immediately after decoding the indicia image. This approach does not require querying a database to associate indicia with coordinates but requires all indicia-associated locations to be known before creating the indicia images (i.e. printing materials with various indicia-associated locations, such as a shopping mall), and each indicia has to be placed at its own unique location.

The method shown in FIG. 14b involves indicia representing unique binary data, which are not geographical coordinates sets, but rather a key to a table and a database having records of coordinates where the current indicia is located. Deployment is thereby simplified as this methodology allows the use of a set of indicia created (e.g., printed) before deployment without knowing the locations which will be matched with the indicia. Association of the indicia with their respective locations is performed during the deployment process.

The steps include scanning indicia 220 and 230 and decoding data from indicia images at 222. In the non-geographical data methodology shown in FIG. 14b, an additional step is required to query the database with a binary key contained in indicia 232. After the device receives the geographical coordinates, it may perform a mapping or any navigational procedure, which receives coordinates and current device orientation as an input at 226.

FIG. 15 shows the steps of a method embodying an aspect of the present invention using non-unique indicia, which allows the system to have binary code encapsulated using shorter indicia and simple flying decoding of the indicia and/or allowing the system to make the indicia smaller in size. The method shown in FIG. 15 has the same steps of scanning 220 and decoding binary data and orientation 222 as previously described, but has an additional step 230 of retrieving a low precision location, which capability is available on many modern cellphones using cell tower triangulation. The binary data from the indicia and the low precision location data are used to query the database to retrieve the particular indicia location. After the device receives the geographical coordinates, it may perform a mapping or navigational procedure at 226 using the coordinates and the current device orientation as an input. By associating indicia with two or more coordinates, the system enables navigational instructions including stops between the origin and the destination.

FIG. 16a shows a billboard 150 representing a shopping mall directory with a mall map 152 including the location of the billboard 150 in the mall so that a portable device 22 can use its location to display the map on a screen centered on the current position. The billboard may have a list of departments 154, 158 and additionally may have indicia 156 displayed for scanning by a portable device 22 in order to facilitate inputting destinations. The portable device 22 may be capable of scanning multiple sets of indicia at a time and the system software may provide the user with a choice to select one of a number of destinations for which location and other information has been acquired by the portable device 22. Additional data may be provided for each destination, such as working hours, distance, current and future promotions and available coupons. A link to a store web site or catalog may also be provided.

According to one aspect of the present invention, a method is provided to perform position location and to provide navigational services using optical indicia as sources of location information using a portable device. This can be used in areas where traditional GPS radio signals are not available, such as in buildings, various facilities and constructions. For example, a possible scenario utilizing this method involves a customer entering a facility or a shopping mall and seeing a billboard 150 with a mall map 152 and a list of departments 154, 158. Next to this map 152 there is an optical indicia (special barcode) containing location data, which can be absolute two or three dimensional coordinates, or simply a unique ID, which can be associated with this particular indicia and its location.

The portable device 22 may have preloaded maps and lists of all barcodes posted in the facility, or it may obtain such data over wireless connection from a remote system. In contrast to devices using radio signals to obtain location information, optical indicia can carry positioning (directional) information required to provide initial navigational instructions (e.g., a command such as “turn right and go 100 feet”). In the case of radio signals used in a traditional RF device, the device should be moved and perform at least two reads into different locations to obtain the vector and provide the first directional instruction. Before the device 22 can provide navigational instructions, the customer needs to enter the destination. The customer may select the destination from a preloaded list on the device 22 or from a list received wirelessly from a remote system. Alternatively, the customer can perform a search by name or other criteria. Another way to enter destination information is to provide the destination information in barcode format next to a list of destinations (departments) posted on the billboard 150, which can be scanned and recognized by the portable device 22.

A more convenient way to enter origin and destination information is to combine data from both indicia in one device, from which all the required data for routing can be obtained in a single scan. Having vector, current position and destination information is sufficient to provide traditional navigational instructions.

The indicia can be a human readable alphanumeric text, or machine-readable barcode, or any image which can be uniquely identified and have an image reproduction underwritten. For example, for aesthetic purposes the indicia can be disguised in another image. For example, a “watermark” can be extracted from another image by a special algorithm. Data encapsulated in indicia may be unique for each indicia to allow a unique association with a physical location.

However, if the portable device 22 has other means to approximate the device location (for example, triangulation by cell towers), it is sufficient to have unique indicia only as needed in areas defined by resolution of a low precision navigation means. This would simplify development of the navigational system.

Deployment of the system would consist of assigning physical positions with a set of unique indicia on objects (walls, surfaces) within a building (or facility) and configuring the database to create associations for each position's unique indicia. This database may be remote to the portable device 22 and communicate wirelessly or be copied to it.

As an example of the operation of the system, a user with a portable device 22 (FIG. 2) enters a shopping mall and proceeds to a billboard 150 including a mall map 152 and directories 154, 158 (FIG. 16). The mall map 152 can be oriented in such a way that the departments located on the users last are displayed on the left side of the map 152 and vice versa. Departments or destinations located in front of the user can be displayed on the top of the map. In other words, the map 152 can be configured to facilitate orienting the user. An image of the map rotated 180° can be displayed on the opposite side of the billboard 150. Departments and destinations on the bottom of the map will be behind the user as he or she is viewing the map 152. Left and right orientations of departments and destinations are relative to the viewer's orientation, regardless of which side of the billboard 150 is being viewed. Alternative billboard displays can have multiple sides each with a map 152 corresponding to the orientation of the mall from the viewpoint of a person standing in front of that particular side in order to facilitate direction finding. After scanning the map(s) 152, the portable device 22 can provide displays such as those shown in FIGS. 8a-h. The indicia can also be positioned horizontally on a floor surface for scanning from different angles, which will cause different, corresponding orientations to the displayed on the portable device screen, as shown in FIGS. 8a-h. The portable device determines orientation of indicia by extracting data from which the area and boundaries can be decoded from the scanned image, including start and turns as needed for successfully navigating to various destinations. The scanning technologies can be similar to the algorithms which are used for scanning tracking numbers in barcode and other formats. The posting of full-size maps can be rendered unnecessary by making available the same information on the portable device 22, which can be displayed to the user on the screen.

The portable device 22 can be used to calculate a route and provide turn-by-turn directions to a destination. Destinations may be entered into the device 22 in different ways. For example, the user can select a point on the displayed map 152 and capture the image and data. Alternatively, a desired department or destination can be selected from a menu. The system then determines the user's current location and orientation, and automatically computes and provide an output consisting of the navigational information. The menu can provide lists of departments and specific destinations (e.g., retail establishments) in any suitable format using any suitable criteria, e.g., alphabetical, by department, subject matter, user preference, history, etc. The menu may be customized for particular users' profiles, for example, based on age, gender, buying preferences, etc.

The method of the present invention can provide coverage even without GNSS availability and can search for departments and services available within a particular building or facility. Alternatively, with GNSS availability various information sources can be accessed, e.g. via the Internet world wide web) and department and destination information can be made available based on the user's present location and desired destinations.

Still further, a desired destination can be scanned from the destination indicia 154, 158 (FIG. 16a), which can be posted on the billboard 150 next to each entry in the department listing 156. The destination indicia 154, 158 can be printed in suitable media, such as a booklet, a newspaper, a business card, a guide, etc. Indicia 154, 158 posted on the billboard 150 or another static object can contain both a current location and a destination. A single scan can determine the current location, displaying an oriented map and route with directions to the destination. If the destination indicia is on a nonstatic object, such as printed media, the user can scan static indicia located in the area (e.g., on a wall, floor, etc.) to provide the system with a starting point. If the user is in a remote location and a GNSS signal is available, the navigational procedure may provide driving directions from the user's vehicle location to a location decoded from indicia. On arriving at the destination building or facility the user can then refine his or her current position and the remaining route by scanning static indicia located in route to the ultimate destination.

It is to be understood that the invention can be embodied in various forms and is not to be limited to the examples discussed above. Other components and configurations can be utilized in the practice of the present invention.

Having thus described the invention, what is claimed as new and desired to be secured by Letters Patent is:

1. A method for performing a navigational procedure using a portable device, said method including the steps of:
inputting geographical linkage code from an optical indicia located on a surface to the portable device;
determining an orientation of the scanned indicia relative to the portable device;
extracting data from the indicia;
executing a selected navigational procedure with the extracted data; and
displaying results of the navigational procedure on the portable device according to the position of the device relative to the optical indicia.

2. The method of claim 1 where the portable device is one of a wireless device or a cell phone.

3. The method of claim 1 where the navigational procedure is stored internally in the mobile device.

4. The method of claim 1 where the navigational procedure is stored externally from the mobile device and data is communicated wirelessly with the portable device.

5. The method of claim 1 where the indicia contains absolute geographical coordinates.

6. The method of claim 1 where the indicia contains an identification (ID) which can be associated with absolute geographical coordinates.

7. The method of claim 1 where the association of the ID with absolute geographical coordinates is stored locally on the portable device.

8. The method of claim 1 where the association of the ID with absolute geographical coordinates is retrieved from a remote database.

9. The method of claim 1 where the navigational procedure uses data from the scanned indicia to determine its current location.

10. The method of claim 1 where the navigational procedure uses data from the scanned indicia to determine the location of a destination.

11. The method of claim 1 where the navigational procedure uses a user's input to determine a destination.

12. The method of claim 11 where the user input is a point on a map displayed for the user.

13. The method of claim 11 where the user input is made from a menu provided by the navigational procedure.

14. The method of claim 11 where the user input is a voice command.

15. The method of claim 1 where the navigational procedure uses data from the scanned indicia to determine origin, orientation, destination and route from a single set of indicia.

16. The method of claim 6 where the ID is associated with both origin and destination coordinates.

17. The method of claim 6 where the ID is associated with other information or another procedure presented to the user.

18. The method of claim 6 where the ID association is dynamic and changes with time.

19. The method of claim 6 where the ID association is dynamic and depends on a user profile.

20. The method of claim 1 where the displayed map is an oriented 3-dimensional map or scheme of the surrounding area.
